(19) United States
(12) Patent Application Publication
(10) Pub. No.: US 2016/0110899 A1
(43) Pub. Date: Apr. 21, 2016

(54) METHODS AND SYSTEMS FOR CREATING STORYLINES

(71) Applicant: StoryCloud, Inc., San Diego, CA (US)

(72) Inventors: Kenneth J. KALB, Solana Beach, CA (US); Michael W. Tracy, Solana Beach, CA (US); Barry Shapira, Solana Beach, CA (US)

(21) Appl. No.: 14/515,488

(22) Filed: Oct. 15, 2014

(51) Int. Cl. G06T 11/60; G06Q 50/00; G06Q 30/02; G06F 17/24

(52) U.S. Cl. CPC G06T 11/60; G06F 17/24; G06Q 50/01; G06Q 30/0241

(57) ABSTRACT

Some aspects provide methods and systems that create storylines. The methods and systems receive subject information and storyline content for the storyline. The methods and systems generate the storyline with the story line content in chronological order and transmit the storyline for presentation on a display.

### BACKGROUND

With the proliferation of social media services, content sharing has become increasingly prevalent among internet users. Content is posted to a social media service and shared by others. Content posted to a social media service may be organized based on the date the content was posted. In addition, when other users add content to a social media site, the content is typically uploaded on the date the user adds the content. As such, content may be chronologically out of order on the social media site.

### SUMMARY

Aspects relate to methods and apparatus that allow individuals to create storylines, such as chronological or non-chronological timelines for people, places, things, events, subjects and objects. Storylines may be populated by a creator (e.g., an individual that creates a storyline) or by other individuals, such as any user who may view the storylines. Aspects also relate to methods and apparatus that enable individuals to juxtapose individual storylines against any other storyline created.

Additional advantages and novel features relating to aspects of the present invention will be set forth in part in the description that follows, and in part will become more apparent to those skilled in the art upon examination of the following or upon learning by practice thereof.

### BRIEF DESCRIPTION OF THE FIGURES

In the drawings:

FIG. 1 illustrates an example storyline in accordance with an aspect;

FIG. 2 illustrates an example interface in accordance with an aspect;

FIG. 3 illustrates an example method flow for creating a storyline in accordance with an aspect;

FIG. 4 illustrates an example method flow for contributing storyline content in accordance with an aspect;

FIG. 5 illustrates an example method flow for rating contributions to the storyline content in accordance with an aspect;

FIG. 6 illustrates an example interface in accordance with an aspect;

FIG. 7 illustrates an example interface in accordance with an aspect;

FIG. 8 illustrates an example interface in accordance with an aspect;

FIG. 9 illustrates an example interface in accordance with an aspect;

FIG. 10 illustrates an example connectivity system in accordance with an aspect; and

FIG. 11 illustrates an example computer system in accordance with an aspect.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

The word “exemplary” is used herein to mean serving as an example, instance, or illustration. Any embodiment described herein as “exemplary” is not necessarily to be construed as preferred or advantageous over other embodiments. Likewise, the term “aspect” of an apparatus, method or article of manufacture does not require that all embodiments of the invention include the described components, structure, features, functionality, processes, advantages, benefits, or modes of operation.

Some aspects of the disclosure relate to methods and apparatus that enable users to own, control, manage, publish, monetize, store, organize, and tag a variety of digital assets. The methods and apparatus provide individuals with a highly contextual experience by illustrating how a piece of content may relate to any other piece of content in the system. The methods and apparatus may allow individuals to create storylines to tell a story in a unique, sometimes private or public way. Storylines may be multi-dimensional, of which chronology is one dimension. For example, storylines may include chronological timelines for people, places, things, events, subjects and objects. Storylines may also be ordered, for example, by tag, ranking (e.g., a user likes or follows a storyline), emotion, keywords, themes, location, duration, color schemes, sounds, environment, and/or belief systems. Example storylines may include emotional storylines, physical storylines, or existential storylines. Storylines may allow individuals to publish a story online using different forms of content that already exist or content extemporaneously created in real or near real time using a device. For example, an individual may use a storyline to tell a story with images, text, videos, blogs, sound effects, and music. In addition, users may be able to incorporate third party content (e.g., images, blogs, URL links, schedules, music, documents, and portions of other individual's storylines) into the individual's storyline. The individual may manage and control content added to the storylines created by the individual. Storylines may be populated by a creator (e.g., an individual that creates a storyline) or by other individuals, such as any internet user who may view the storylines. The described aspects may incorporate “wisdom of the crowd” to contribute to storylines. As such, the described aspects may create a crowd sourced collection of digital assets. In one embodiment, the storylines may be non-chronological. A storyline may be based on feelings and perceptions instead of linear time. A user could create a storyline based on content, such as a song, video, or image, and populate the storyline with other content, notes, images, and the like.

Aspects of the disclosure also relate to methods and apparatus that enable advertisements to be presented in the storylines. The advertisements may relate to the storyline content and may be chronologically displayed on the storylines. Corporations and/or organizations may monetize the storyline content by presenting relevant advertisements near the events and items presented on the storyline.

In addition, aspects of the disclosure relate to methods and apparatus that enable individuals to juxtapose individual storylines against any other storyline created. For example, individuals may be able to compare a personal storyline relative to other storylines (e.g., a friend's storyline or a storyline for a celebrity). Individuals may also be able to juxtapose any storylines created against one another. As an example, an individual may be able to juxtapose a storyline for building the Empire State Building against a storyline for building the Gherkin. Storylines may also be used as research resources illustrating what was happening, for example, in other industries, at competitors, and other geographic locations, among other information. In addition, if a plurality of individuals attempt to accomplish a same task, multiple storylines of the individuals may be illustrated together. The individuals may be able to track their progress relative to other individuals who are performing the task and/or have completed the task. As such, the methods and apparatus may be able to provide individuals with a contextual experience by being able to visualize context. For example, individuals may be able to visualize how a piece of content relates to everything else by comparing various storylines easily.

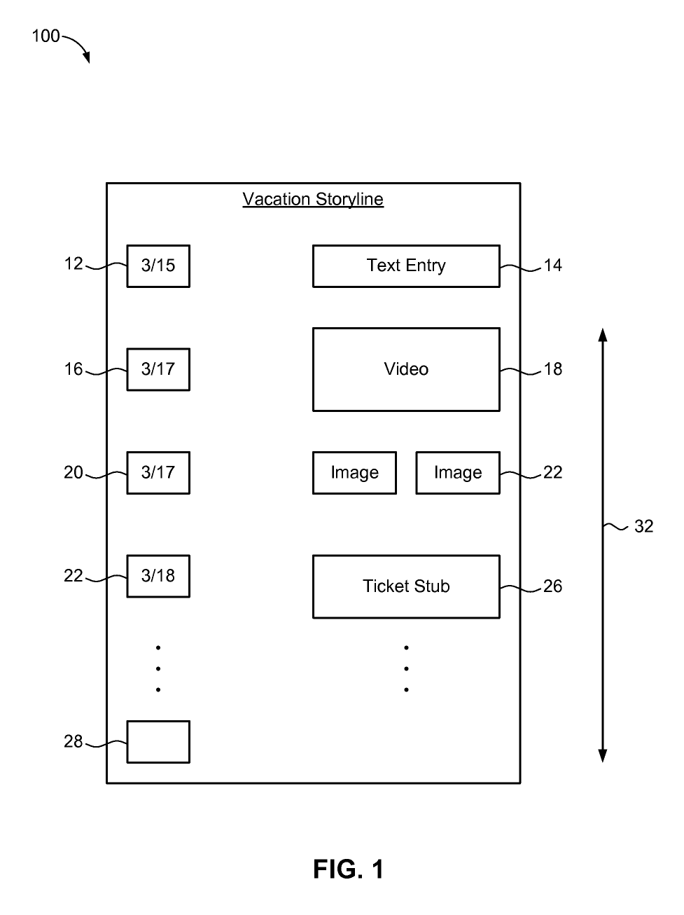

Referring now to FIG. 1, illustrated therein is an example storyline 100 for a vacation in accordance with an aspect. Storyline 100 may include a start date for the vacation 12 and a text entry to document the start of the vacation 14. In addition, storyline 100 may have chronological date entries with additional storyline content related to the vacation for each of the date entries. For example, storyline 100 may include a video 18 of the vacation a date 16 the video was captured. In addition, one or more images from the vacation 22 may be uploaded to storyline 100 on the date 20 the images were taken. In addition, storyline 100 may include a ticket stub 26 for a performance on the date 24 that a group of individuals attended the performance. In an aspect, the various storyline content (e.g., video 18, images 22, document 26) may be uploaded by any individual on the vacation. For example, if a family goes on vacation together, each family member may be able to upload items from the vacation to the storyline. As such, storyline 100 may store and organize content from the vacation so that a plurality of family members who went on the vacation may easily view and/or contribute content to the storyline.

In an aspect, the storyline content in storyline 100 may be displayed in real-time, or near real-time, as the storyline content changes. For example, when storyline content is added to storyline 100, the storyline content may be inserted into chronological order of the storyline 100. The storyline content may be moved upwards and/or downwards accordingly to maintain the chronological order of the timeline. In an aspect, storyline 100 may scroll in an upward direction and/or a downward direction 32 as new storyline content is added to storyline 100. It should be noted that other mechanisms for updating a presentation of storyline 100 may also be utilized, such as by scrolling in another direction or replacing an entire presentation or view of information with a new presentation or view of updated information.

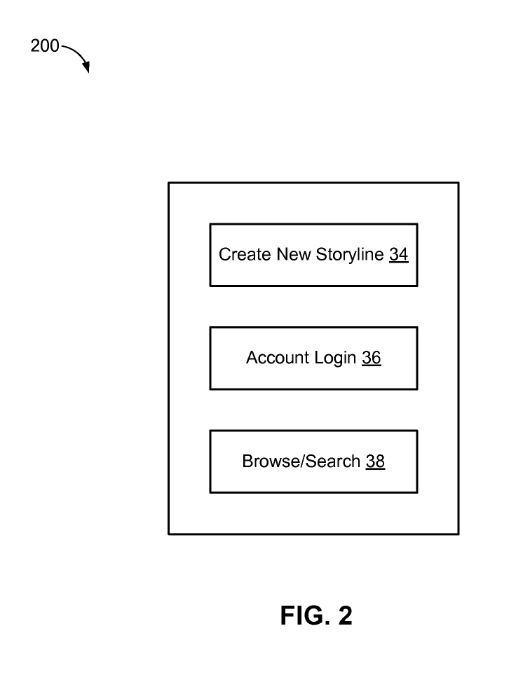

Referring now to FIG. 2, illustrated therein is an example interface 200 for display on a device in accordance with an aspect. Interface 200 may be presented to a user when the user downloads a storyline application onto a device associated with the user. In addition, interface 200 may be presented to a user when the user accesses and/or views a storyline application from a device (e.g., from a web page on the device).

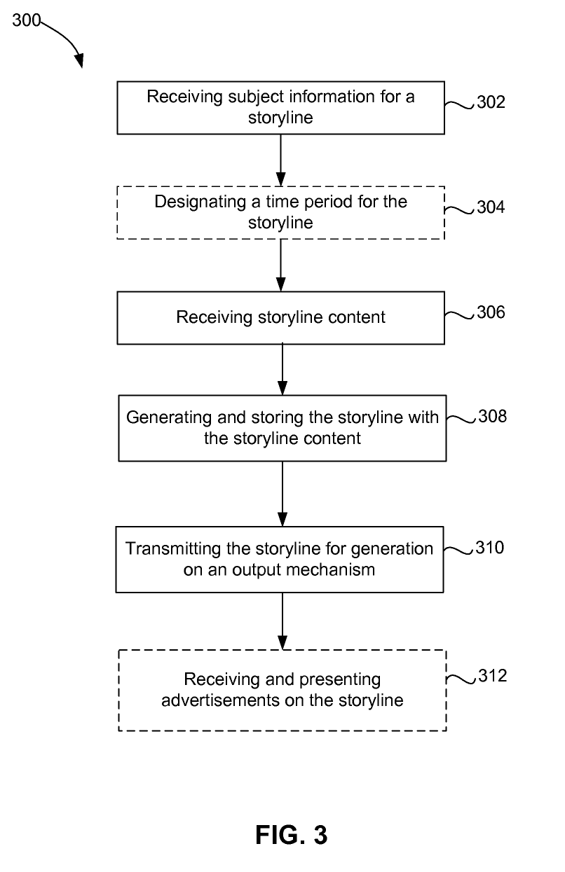

A user may select Create a New Storyline 34 to create one or more storylines, as discussed in FIG. 3. A user may designate the new storyline as private where only the user, or a limited number of individuals, may view and/or contribute to the storyline. In addition, the user may designate the new storyline as public so that other individuals (e.g., any internet user) may be able to view and/or contribute to the storyline. Storylines may be shared and compartmentalized so that portions of one user's storyline may be incorporated into another user's storyline.

A user may also log into a user account of the system 36 and view one or more storylines associated with the user. For example, the user may have created one or more storylines (e.g., a personal storyline, a storyline for a landmark, a storyline for a public figure, etc.) and/or may be following storylines created by other individuals. A user may follow other storylines by selecting specific contributors and/or specific subjects to follow. For example, a user may receive information about and/or receive storylines of the specific contributors and/or specific subjects. In an aspect, the system may display the storylines for the user account on a dashboard and/or a feed with the storyline content. The storyline content displayed may change over time and the dashboard and/or feed may be updated, in real-time, or almost real-time with the respective changes. The dashboard and/or feed may notify a user of any contributions and/or changes to the storyline content (e.g., additions, deletions, revisions).

In addition, a user may Browse or Search for a storyline 38. A user may use keywords, dates, locations, and/or names to search for a storyline. The system may prioritize storylines by date and time, location, and people. For example, a user may type in the keyword “silicon” and prioritize by location. The system may display a storyline associated with Silicon Valley, Calif. If the user prioritized the keyword “silicon” by the oldest date, the system may display a storyline for silicon (the substance) including a date of invention, the inventor name, and any associated storyline content (e.g., an image of the inventor, a video of silicon being used, a document discussing the composition of silicon). The system may display the search results to the user. A user may browse and/or search for storylines from a user account and/or from interface 200. As such, both members (e.g., users that have system accounts) and non-members (e.g., any internet user) may discover other storylines by searching and/or viewing storylines.

Referring now to FIG. 3, illustrated therein is an example method flow 300 for creating a new storyline in accordance with an aspect. Storylines may be multi-dimensional, of which chronology is one dimension. For example, storylines may include chronological timelines for people, places, things, events, subjects and objects. Storylines may also be ordered, for example, by tag, ranking (e.g., a user likes or follows a storyline), emotion, keywords, themes, location, duration, color schemes, sounds, environment, and/or belief systems. Example storylines may include emotional storylines, physical storylines, or existential storylines. In an aspect, a user may select create a new storyline 34 (FIG. 2) from the storyline application interface to create a new storyline. In addition, a user may log into a user account 36 (FIG. 2) on the system to create a new storyline. The user may control the new storyline by limiting the viewership of the storyline, adding and/or removing individuals who may view the storyline, creating rights and/or privileges for users to edit or add storyline content, and sharing the storyline with individuals. A user may designate the new storyline as private where only the user, or a limited number of individuals, may view and/or contribute to the storyline. In addition, the user may designate the new storyline as public so that other individuals (e.g., any internet user) may be able to view and/or contribute to the storyline. The user may also compartmentalize portions of the storyline designating portions of the storyline as private and/or public. In addition, the user may designate portions of the user's storyline that may be incorporated into other individual's storylines. In an aspect, public storylines may be sponsored storylines that are created as an official storyline for a person, place, thing, topic, and/or object. The user may also designate a portion of the storyline as private (e.g., only a limited number of individuals may view the portion of the storyline) while designating other portions of the storyline as public.

The method may include receiving subject information for a storyline 302. Subject information may include, but is not limited to, a person, place, thing, topic, and/or object. Example subject information for storylines may include an individual, corporations, landmarks, historical figures, celebrities, public figures, games, museums, music, and sports. In an aspect, the system may receive user input for the subject information from a device of the user. For example, the user may input one or more subject information on the device using a drop down menu, inputting text, and/or speaking the subject information, among other user interface mechanisms for inputting information. In an aspect, the storyline may extend indefinitely into the past and/or future. For example, the storyline may project out into the future plans and/or expected events. In addition, the storyline may include a temporal beginning and/or end.

The method may optionally include designating a time period for the storyline 304. The time period may include a start date and/or end date of the storyline. The time period may also designate when contributions may occur to the storyline. For example, a user that creates a storyline may only allow contributions to the storyline over a three week period. The system may receive user input for the time period from a device of the user. In addition, the system may automatically designate a time period for the storyline. The system may import information from a calendar and use scheduled appointments, events, deadlines, goals, due dates, and/or milestones to determine an end date for the storyline. For example, a user may input the start date for a storyline for a project and the system may automatically select an end date for the storyline by retrieving a scheduled due date for the project from a calendar associated with the user. The system may compare the subject information for the storyline (e.g., the project name) with the name of entries in the calendar and when a match occurs, the system may import the date information for the calendar entry into the storyline.

In addition, the method may include receiving storyline content 306. Storyline content may include, but is not limited to, any type of document, note, blog, e-mail message, text message, multimedia file, image file, audio file, presentation, music, video, electronic book, schedules, an electronic representation of a physical item, language, typeface, character set, or any other type of media or information that may be rendered, processed, or executed on a device. The user may use a variety of storyline content to tell a story. The user may use storyline content that already exists or storyline content extemporaneously created in real or near real time using a device to tell a story. The user may also incorporate different elements and/or storyline content from a multitude of storylines to build a personal story about an idea or subject. As such, the user may be able to compile a plethora of storyline content assembled from almost any digital asset available to the user. For example, the user may use images, videos, and third party content (e.g., images, blogs, URL links, schedules, music, documents, and other individual's storylines) to tell a story about the user's favorite places to visit in a city. In addition, users of the system may use the same or different storyline content to tell the same story from a different perspective. For example, a six year old boy going to Yankee stadium for the first time might describe the loud sound and flashing lights of the New York subway system and the roar of the crowd from Yankee stadium to describe his experience in his storyline. While his mother may use a completely different set of images and sounds to describe the very same experience in her storyline.

The system may receive storyline content, for example, from user input on a device. In addition, the system may retrieve the storyline content from one or more data repositories. In an aspect, the storyline content may be related to the subject information for the storyline. For example, if the subject information for the storyline is “Abraham Lincoln,” the storyline content may be letters written to and/or from Abraham Lincoln, images of Lincoln's family and friends, and audio recordings of interviews about Lincoln.

The method may also include generating and storing the storyline 308. The system may use, for example, the received storyline content, the subject information, and/or the time period to generate the storyline. The system may order the received storyline content in chronological order when generating the storyline. In an aspect, the system may receive a predefined number of storyline content before generating the storyline. For example, after the system receives three items of storyline content, the system may generate the storyline. The system may prompt a user when additional storyline content may be required (e.g., the system may notify the user that two additional items of storyline content is required to create a storyline). The system may also store the generated story lines. For example, if the storyline has been tagged as private, the system may store the storyline and may associate access rights to the storyline with the user account that created the storyline.

In addition, the method may include transmitting the storyline for generation on an output mechanism 310. For example, the system may transmit the storyline for presentation on a display of a device so that one or more users may view the storyline.

The method may optionally include applying one or more filters to the storyline content to aid in the presentation of the storyline content. The system may include a variety of content filters that may be used when presenting the multiple media formats of the storyline content. For example, a digital image filter may adjust three or four elements in the image (e.g., saturation, contrast, brightness) when presenting images in the storyline. The system may apply the filters to third party content, storyline content found in other storylines, and/or organically created storyline content. In an aspect, the filters may also include predetermine content requirements for uploading and/or placing storyline content in a storyline. When uploading music, images, videos, audio, and geo-location storyline content, the system may, for example, use the filters to ensure that the predetermined content requirements for a particular format of storyline content is used.

The method may optionally include receiving and presenting advertisements on the storyline 312. The system may receive and present one or more advertisements related to the storyline content on the storyline. In an aspect, the system may receive advertisements from companies and organizations referenced in the storyline content. For example, when the storyline content links to a company (e.g., a URL link to a movie theater or online store where the user purchased items), tags a company in storyline content (e.g., a user commenting on a restaurant where they ate), and/or imports storyline content from an organization (e.g., an events schedule for an organization), the system may receive advertisements from the companies and organizations mentioned in the storyline content to present on the storyline. In addition, when the storyline is a company or organization sponsored storyline, the system may receive advertisements from the company or organization to present on the storyline in a chronological order. As such, the storyline may be used to display advertisements in a chronological order to all types of individuals and organizations that may view the storyline.

In another aspect, the system may select advertisements that are related to the storyline content to present on the storyline. The system may match the subject matter of the storyline content to one or more advertisements received to determine which advertisements may be related to the storyline content. For example, the system may perform pattern recognition on the images included in the storyline content and determine advertisements that are related to the images. In addition, the system may search the text of storyline content and identify keywords and/or phrases from the text and use the keyword and/or phrases to determine advertisements that are related to the storyline content. The advertisements presented by the system may be incorporated into the chronological events presented on the storyline timeline. As such, companies and organizations may use other individuals' storylines to monetize upcoming schedules and/or events, services, and products by publishing relevant advertisements near individual's personal interests and/or professional interests.

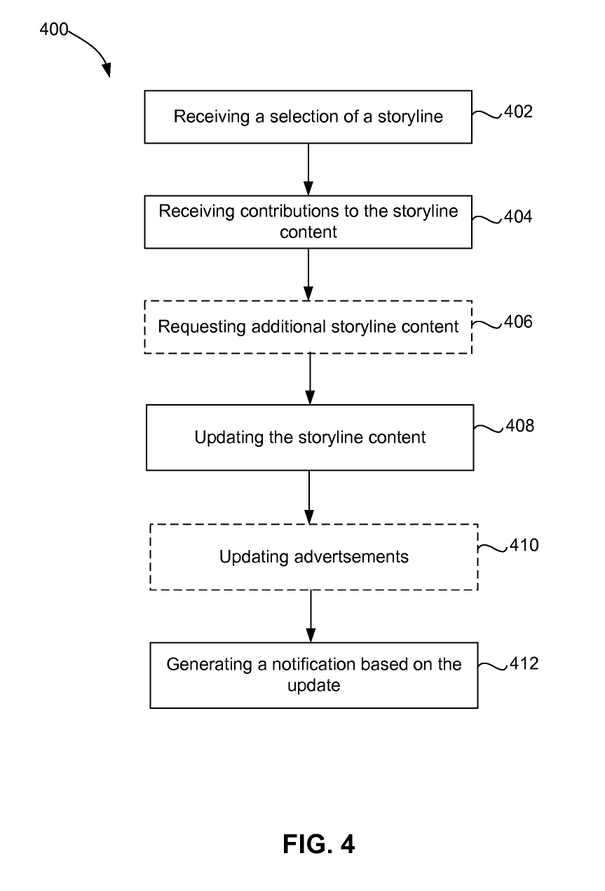

Referring now to FIG. 4, illustrated therein is an example method flow 400 for contributing to a storyline in accordance with an aspect. For example, a user may update and/or add additional storyline content to a storyline. In addition, other users may contribute storyline content to a storyline. The method may incorporate “wisdom of the crowd” to contribute to and/or update storyline content. As such, the method may create a crowd sourced collection of storyline content.

The method may include receiving a selection of a storyline 402. In an aspect, a user may log into a user account of the system and view one or more storylines associated with the user. For example, the user may have created one or more storylines (e.g., a personal storyline, a storyline for a landmark, a storyline for a public figure) and/or may be following storylines created by other individuals. The system may display the storylines for the user account on a feed and/or a dashboard view. The user may select a storyline from the feed and/or dashboard to provide a contribution to the storyline content.

In another aspect, a user may browse and/or search for a storyline. For example, a user may use keywords, dates, locations, and/or names to search for a storyline. The system may prioritize storylines by date and time, location, and people. The system may display the search results and the user may select a storyline from the search results to provide a contribution to the storyline content.

The method may also include receiving contributions to the storyline content 404. Contributions may include, for example, additions, revisions, and/or deletions to the storyline content. Contributions may occur to private storylines and/or to public storylines. For example, the system may receive contributions to one or more selected storylines. Users of the systems may upload storyline content (e.g., images, documents, videos, maps) to the system, drag and drop storyline content, input text, and/or speak the storyline content, among other user interface mechanisms for inputting information.

Optionally, the method may include requesting additional storyline content 408. A user of the system may select other individuals to receive a request for additional storyline content. The request may identify specific storyline content, such as a birthday photo, a letter, or content from an event. In addition, the request may be a general request for any storyline line content that may be relevant to the storyline. The system may receive the contact information for the selected individuals and transmit a request via, for example, an e-mail message, a SMS (Short Message Service) text message, and push notifications to selected individuals. In an aspect, the user may select the individuals from a contact list associated with the user (e.g., social media contacts, an address book) and provide the system with access to the content list. The system may automatically obtain the contact information for the selected individuals from the contact list and send to the request to the selected individuals.

The requests sent by the system may accelerate user growth of the system and/or user engagement of the system. As more users receive requests to contribute content, the users may engage with the system by viewing storylines and/or by contributing storyline content. In addition, users that receive requests for content may create personal storylines and send out additional requests for storyline content. As such, a viral cycle may be initiated as more users receive and/or send requests for storyline content.

The method may include updating the storyline content 408. The system may rearrange the storyline content based upon the contributions received to maintain a chronological order of the storyline content. For example, if a user adds storyline content, the system may move and/or append storyline content with the additional storyline content received. In addition, if a user deletes storyline content, the system may remove the storyline content from the storyline. In an aspect, a creator of a storyline may be able to edit and/or remove any storyline content contributed to the storyline. In addition, a creator of a storyline may be able to confirm that storyline content should be removed from the storyline prior to the system deleting the storyline content.

The method may optionally include updating advertisements for the storyline 410. The system may update and/or add advertisements to the storyline based on the updated storyline content. For example, if the updated storyline content linked to a movie theater, the system may retrieve the upcoming movie schedule for the movie theater and update an advertisement location on the storyline near the movie theater storyline content entry with the upcoming movie schedule. In addition, the system may remove advertisements from the storyline based on the storyline content. For example, if a user removed an entry on the storyline about a restaurant where the user ate, the system may remove an advertisement by the restaurant from the storyline.

The method may also include generating a notification based on the update 412. Notifications may include, for example, e-mail messages, SMS text messages, and/or push notifications. A user of the system may select a notification preference for receiving notifications from the system. The system may generate and send a notification to the user when a contribution occurs to the storyline. In addition, the system may present any updates to the storylines when a user logs into the user's account. For example, the system may update a dashboard or feed in real or near-real time with the updates. As such, a user of the system may easily view any contributions made to the storyline.

An example use case may include a mother using the system to create a storyline for her daughter. The mother may log into the system and select her daughter's birthday as the start date for the storyline and may populate the storyline with pictures, videos, audio clips, and stories about her daughter. The mother may use the system to send requests to friends and/or family members to populate portions of her daughter's storyline with pictures and videos from events. By receiving storyline content from other individuals, the daughter's storyline may capture events from different angles and/or perspectives.

Another use case may include Joe receiving an e-mail from Mary, a user of the system, requesting that Joe upload any relevant content he might have from their shared junior high experience. Joe locates old photos and a school project that Mary and Joe worked on together in junior high and uses the system to upload the photos and the project to Mary's storyline. Joe may use the system to create his own storyline and may upload his camera roll from his cellular phone. Joe's storyline may be populated with images that date back to the purchase of the cellular phone. In addition, Joe may use the system to send requests out to some high school friends and former work colleagues to help populate his storyline. A couple of days later, Joe receives a push notification from the system indicating that two of the individuals Joe contacted uploaded relevant content to Joe's storyline. Joe may log into the system to view the added pictures and skateboarding video uploaded to the storyline. Joe may send out additional requests to other individuals to help populate his storyline.

Another user case may include a corporation creating an official corporate storyline for the corporation. The corporate storyline may include storyline content about the founding of the corporation, company information, employee information, major highlights of the corporations, and events the corporation has hosted and/or sponsored. In addition, the corporate storyline may include public relation information, upcoming schedules and events for the corporation. The corporation may use the corporate storyline to chronologically publish the past, present and future of the company in an organized manner.

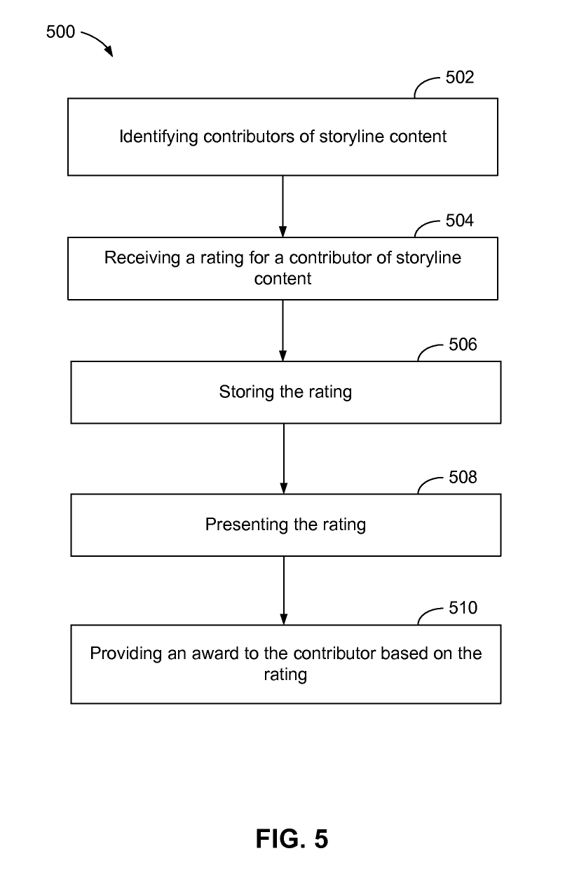

Referring now to FIG. 5, illustrated therein is an example method flow 500 for rating contributions to the storyline content in accordance with an aspect. The method may include identifying contributors of storyline content 502. In an aspect, the system may tag storyline content with the author of the contribution so that users of the system may easily identity the individual who wrote and/or added the contribution. The system may display the individual contributor adjacent to the storyline content. In addition, the system may display the individual contributor when a user highlights, or otherwise selects, the storyline content (e.g., the individual contributor may be displayed in a box overlaying and/or next to the storyline content when the user selects the storyline content).

The method may also include receiving a rating for a contributor of storyline content 504. In an aspect, the rating may be based upon a volume of contributions to storylines. The system may increment a counter each time a user contributes to a storyline and correlate the counter value to the rating. For example, a user that provides multiple contributions to storylines may have a higher rating relative to a user that provides a minimum number of contributions to the storyline.

In addition, the rating may be based on the quality of the contribution. The system may receive feedback information, such as a review, from one or more users of the system for the contributor. For example, the users may input text with a review of the contributor's storyline content and/or select a number of stars (e.g., 3 out of 5 stars) for a review of the contributor's storyline content.

In addition, the method may include storing the rating 506. The system may store any ratings received for the contributors. For example, the system may associate any ratings received for the contributors with the contributor's user account. As such, a contributor may be able to view any ratings received for the contributions provided when logging into the contributor's user account.

The method may include presenting the rating for a contributor 508. The system may display the rating for a contributor adjacent to the storyline content. In addition, the system may display the rating when a user highlights, or otherwise selects, the storyline content and/or the contributor.

The method may also include providing an award to the contributor based on the rating 510. Awards may include, but are not limited to, additional account privileges, additional storage, additional accounts, monetary rewards, gift cards, and/or credits that may be redeemed for a reward. The system may generate and apply an award to the contributor's account based upon the rating for the contributor. For example, the system may provide a contributor with a percentage of storage for every fifteen comments the contributors provide to storylines in the system. In addition, the system may provide the contributor with additional account privileges (e.g., more editing rights to public lines) when users of the system provide a positive rating for the quality of the contribution. For example, if the user ratings of the contribution are above a threshold limit (e.g., a number of users have rated the quality 3 out of 5 stars or above or the text of the ratings is positive), the system may determine that the quality of the contribution is high and provide an award to the contributor. If however, the user ratings of the contribution are below a threshold limit (e.g., a number of users have rated the quality 2 out of 5 stars or below or the text of the ratings are negative), the system may determine that the quality of the contribution is low and the system may postpone providing an award to the contributor.

The rewards and/or ratings may be used by contributors to establish an authority and/or credibility for the storyline content contributed. For example, storyline content from contributors with a high rating may earn special awards, badges and/or notoriety. Contributors may be incentivized to provide more storyline contributions. In addition, contributors may encourage friends and/or other individuals to rate the contributed storyline content to earn more rewards.

Another use case may include, for example, when reading a storyline for Abraham Lincoln, the reader may identify who wrote what contribution and may choose to follow the contributor. For example, the system may identify other storylines created by the contributor and display the other storylines to the user. As such, the user may be able to discover other storylines by following specific contributors.

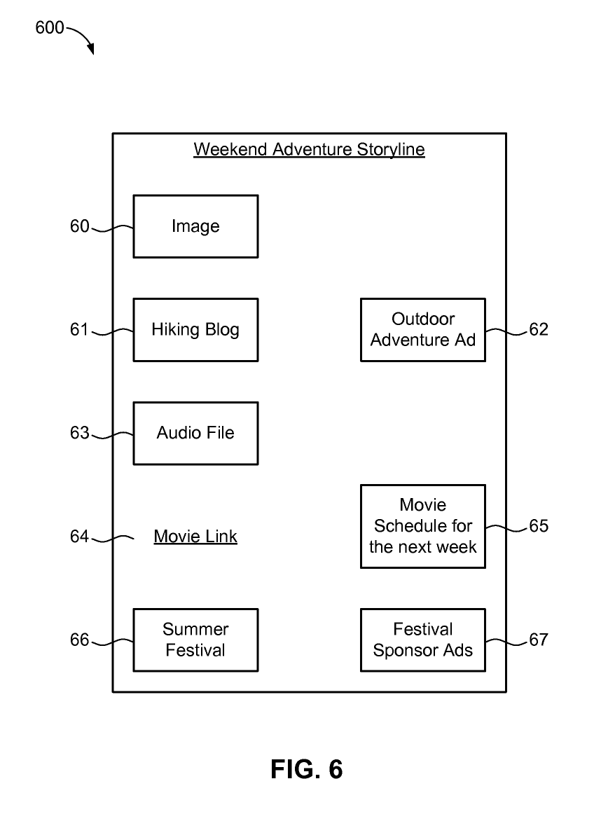

Referring now to FIG. 6, illustrated therein is an example interface 600 for display on a device with a weekend adventures storyline in accordance with an aspect. For example, a user may create a weekend adventure storyline with events and/or highlights of the weekend arranged chronologically. The weekend adventure storyline may include a picture 60 from brunch with friends. In addition, the weekend adventure storyline may include a hiking blog 61 about a hiking trail the user hiked over the weekend along with a soundtrack 63 that the user listen to while hiking The weekend adventure storyline may also include an outdoor adventure advertisement 62 presented near the hiking blog 61. The system may retrieve one or more advertisements related to the storyline content to present to the user. In an aspect, a sponsor of the hiking blog 61 may transmit an advertisement to the system to present near the hiking blog 61. In another aspect, the system may retrieve one or more advertisement to present based on the subject matter of the hiking blog 61.

In addition, the weekend adventure storyline may include a movie link 64 to a movie the user watched at a movie theater. The weekend adventure storyline may also include a movie schedule advertisement 65 with the movie schedule for the following week of the movie theater. The system may retrieve the movie schedule for the movie theater associated with the movie link 64 and present an advertisement with the movie schedule for the following week. The weekend adventure storyline may additionally include a summer festival 66 the user plans to attend over the weekend. Different individuals who may view the user's weekend adventure storyline may want to coordinate with the user to join the user at the summer festival 66. In addition, the system may present advertisements and/or promotions from festival sponsors 67 on the weekend adventure storyline. For example, one of the advertisements displayed may include discount tickets for a group of individuals to attend the summer festival or an incentive to purchase an item at the festival. As such, the festival sponsors may monetize the advertisements on the weekend adventure storyline to encourage additional participation at the festival.

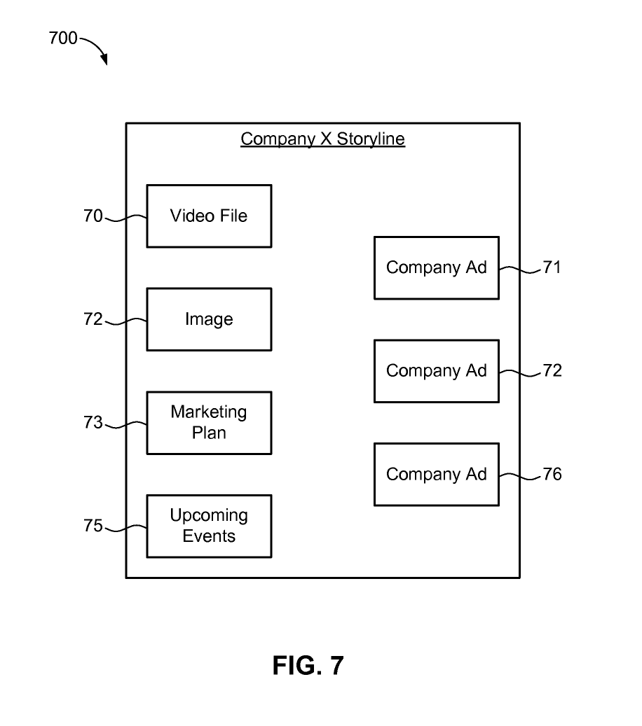

Referring now to FIG. 7, illustrated therein is an example interface 700 for a company's storyline in accordance with an aspect. The company's storyline may include a video 70 for a ground breaking ceremony for the company. The company's storyline may also include a picture 72 from the grand opening of the company. In addition, the company's storyline may include a marketing plan 73 for the company that only a limited number of individuals may view. For example, the user creating the company's storyline may use the system to designate portions of the storyline to have limited viewership (e.g., select individuals may view the content of the storyline) while other portions of the storyline may be open to the public to view. The company's storyline may also include upcoming events 75 that may be used by the company to market to the public the upcoming events. The system may also receive advertisements 71, 74, and 76 to present on the company's storyline. The advertisements 71, 74, and 76 may be generated by the company for various products and/or services provided by the company.

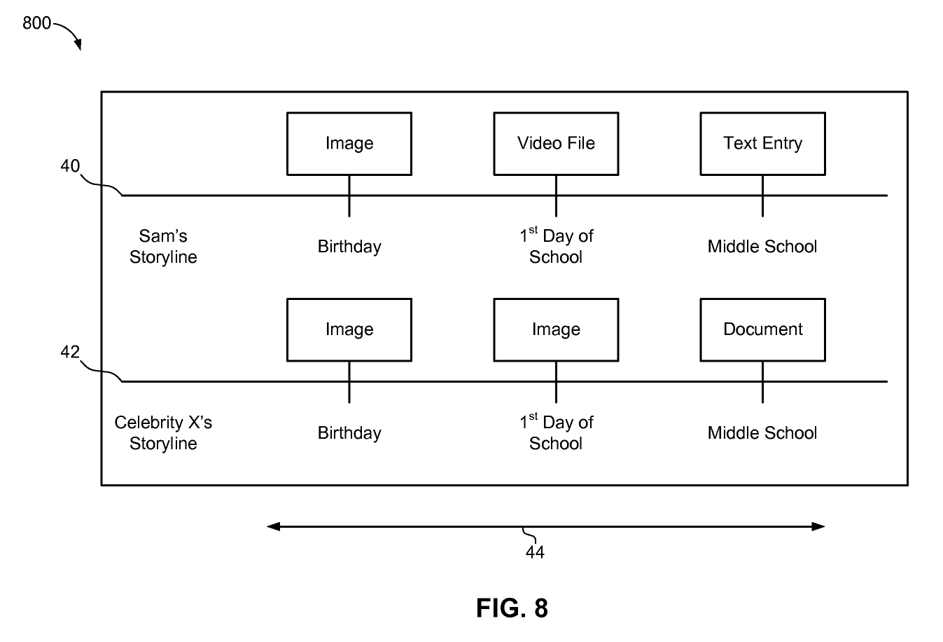

Referring now to FIG. 8, illustrated therein is an example interface 800 for display on a device for comparing multiple storylines in accordance with an aspect. For example, a user may display a personal storyline 40 and select a storyline of a celebrity 42 to display on interface 800. Interface 800 may present both storylines near one another so the user may compare events and/or milestones from the user's personal storyline 40 against similar events and/or milestones from the celebrity's storyline 42. The user may be able to scroll 44 forwards and/or backwards in the storylines to review additional dates in the storylines. In addition, the user may select a time period for displaying the storylines. For example, the user may select a start date and an end date for the comparison and interface 800 may display the storylines between the selected start date and end date. A user may be able to add and/or remove storylines to interface 800 for additional comparisons.

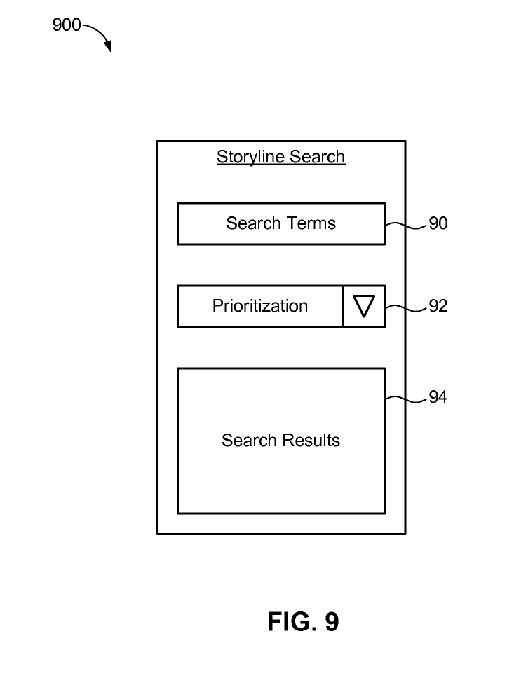

Referring now to FIG. 9, illustrated therein is an example interface 900 for searching storylines in accordance with an aspect. A user of the system may use interface 900 to search and/or browse storylines for new and/or interesting storylines that may be of interest to the user. Interface 900 may include a search term input 90 to receive one or more user search terms. Search terms may include, for example, keywords, dates, locations, or names of people. Interface 900 may also include a prioritization input 92 to receive a prioritization for the search results. For example, the user may be presented with a list of options to select from for prioritizing the search results. Upon receiving the search terms for the search, the system may present the results of the search results 94. For example, the system may present the storylines that are more relevant to the search terms near the top of the search results list while storylines that are less relevant to the search terms may be presented near the bottom of the search result list. In addition, a user may prioritize the search result list, e.g., by a location and/or a name, and the system may revise the search result list 94 based upon the received prioritization.

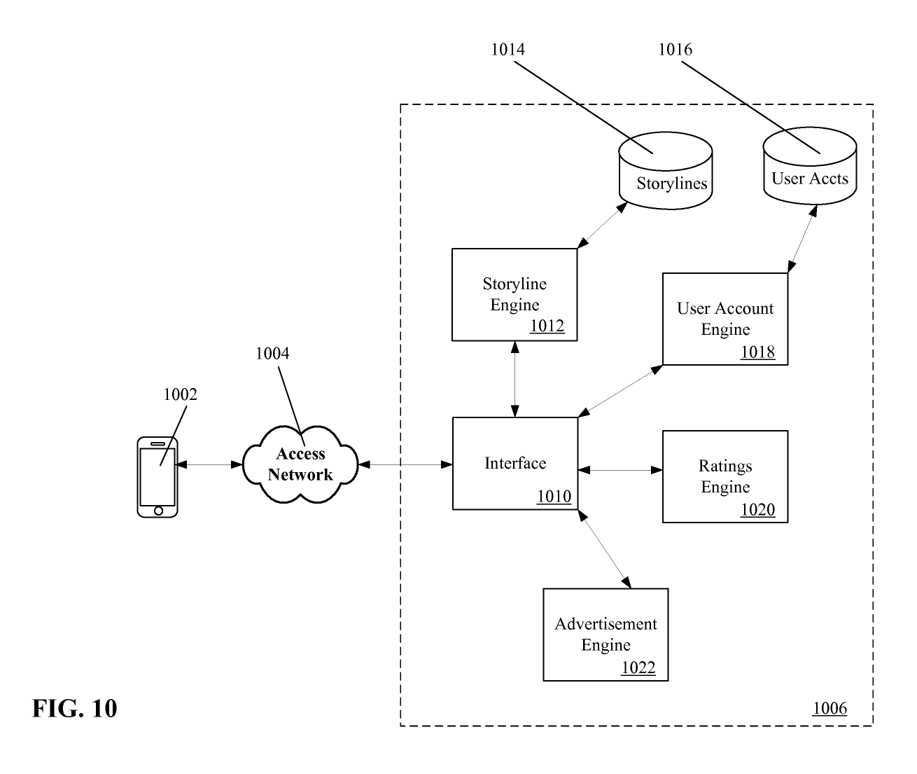

Referring now to FIG. 10, illustrated therein is an example connectivity system 1000 in accordance with an aspect. System 1000 may include one or more wireless devices 1002 communicating through one or more access networks 1004 with one or more servers and/or computing devices 1006. Wireless device 1002 may include any mobile or portable computing or communications device, such as a cellular device, that may connect to an access network 1004. Wireless device 1002 may be, for example, a cellular telephone, a navigation system, a computing device, a camera, a PDA, a music device, a gaming device or a handheld device having wireless connection capability, among other devices. Server/computing device 1006 may include any mobile or fixed computing device connected to a network. Sever/computing device 1006 may include, but is not limited to, a computing device, a server, a cellular telephone, a camera, a PDA, a music device, a gaming device, a navigation system, or a handheld device having wireless connection capability, among other devices. Furthermore, access network 1004 may provide one or more types of communication connections, such as any type of wireless airlink, to wireless device 1002 and server 1006.

Server 1006 may include an interface 1010 that communicates with wireless device 1002. When a user of wireless device 1002 accesses the system (e.g., when a user downloads and/or accesses the storyline application), interface 1010 may transmit communications to wireless device 1002 and/or receive user input from wireless device 1002. In addition, interface 1010 may be communicatively coupled to storyline engine 1012, user account engine 1018 and ratings engine 1020.

Storyline engine 1012, which communicates with interface 1010, may receive user input from wireless device 1002 to create a storyline. Storyline engine 1012 may generate and transmit the created storylines for presentation on wireless device 1002. In addition, storyline engine 1012 may store the created storylines in a storyline data repository 1014. Storyline engine 1012 may also receive user input from wireless device 1002 with a contribution to a selected storyline. Storyline engine 1012 may retrieve the selected storyline from storyline data repository 1014 and update the storyline based upon the received contribution. Storyline engine may communicate with interface 1010 and transmit the revised storyline for presentation on wireless device 1002. Storyline engine 1012 may also store the revised storyline in storyline data repository 1014. In addition, storyline engine 1010 may receive user search criteria from wireless device 1002 to use when searching for a storyline. Storyline engine 1010 may retrieve one or more storylines from storyline data repository 1014 that may be relevant to the search criteria received from wireless device 1002. Storyline engine 1010 may communicate with interface 1010 to transmit the search results to wireless device 1002.

User account engine 1018 may associate a set of user account credentials with one or more users of the system. For example, user account engine 1018 may communicate with interface 1010 and receive user account information (e.g., a username and password) for a user of wireless device 1002. User account engine 1018 may store the received user account credentials in a user account data repository 1016. In an aspect, user account engine 1018 may associate storylines stored in storyline data repository 1014 with the user account information from user account data repository 1016. As such, a user of wireless device 1002 may access a user account for the user and may be able to view any associated storylines for the user.

Ratings engine 1020 may communicate with interface 1010 and receive user feedback from wireless device 1002 for storyline content contributed to the storylines. Ratings engine 1020 may accumulate the feedback received for the storyline content and/or contributors of the storyline content. For example, ratings engine 1020 may increment a counter each time a user contributes to a storyline and correlate the counter value to a rating. In addition, ratings engine 1020 may determine quality of the contribution based upon the received feedback. Ratings engine 1020 may generate any rewards and/or awards to the contributors of storyline content based upon the received feedback and/or the counter value.

Advertising engine 1022 may communicate with interface 1010 and storyline engine 1012 to retrieve and present advertisements on the storyline. Advertising engine 1022 may also match the subject matter of the storyline content to one or more advertisements received to determine which advertisements may be related to the storyline content.

Many of the above-described features and applications are implemented as software processes of a computer programming product. The processes are specified as a set of instructions recorded on a machine readable storage medium (also referred to as machine readable medium). When these instructions are executed by one or more computational or processing unit(s) (e.g., one or more processors, cores of processors, or other processing units), they cause the processing unit(s) to perform the actions indicated in the instructions. Examples of machine readable media include, but are not limited to, CD-ROMs, flash drives, random access memory (RAM) chips, hard drives, erasable programmable read-only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

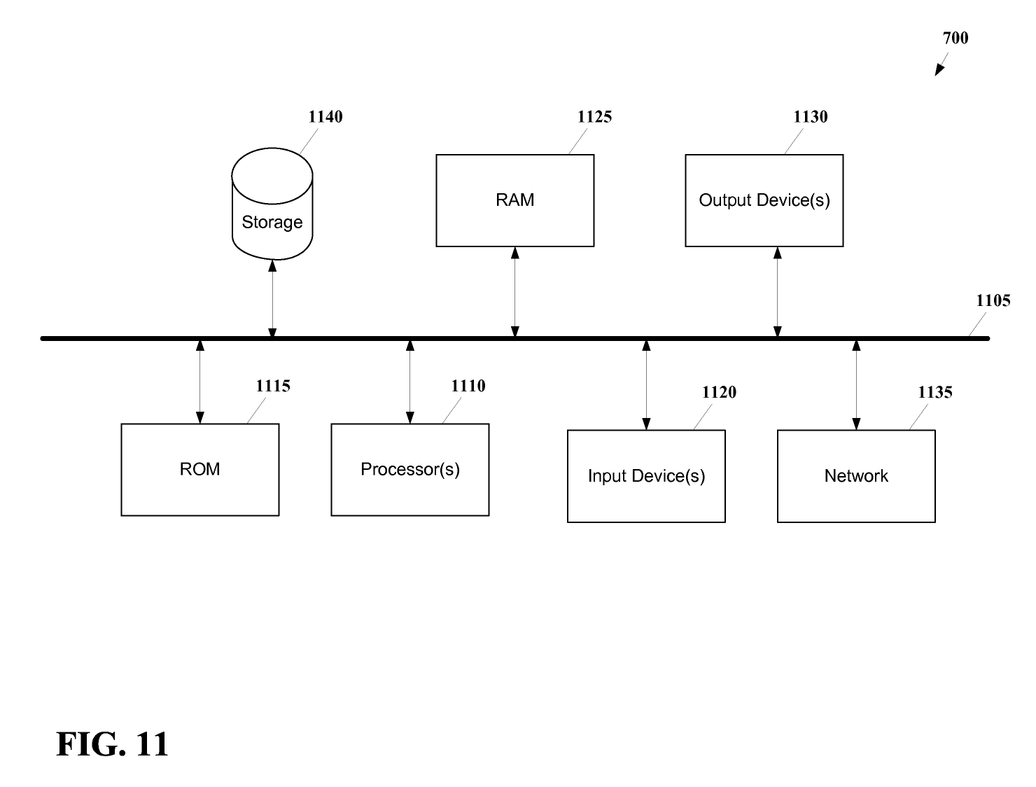

FIG. 11 illustrates an exemplary computer system 1100 that may implement the electronic message service server. The computer system includes various types of computer readable media and interfaces. The system includes a bus 1105, processors 1110, read only memory (ROM) 1115, input device(s) 1120, random access memory 1125, output device(s) 1130, a network component 1135, and a permanent storage device 1140.

The bus 1105 the communicatively connects the internal devices and/or components of the computer system. For instance, the bus 1105 communicatively connects the processor(s) 1110 with the ROM 1115, the RAM 1125, and the permanent storage 1140. The processor(s) 1110 retrieve instructions from the memory units to execute processes of the invention.

The ROM 1115 stores static instructions needed by the processor(s) 1110 and other components of the computer system. The ROM may store the instructions necessary for the processor to execute the web server, web application, or other web services. The permanent storage 1140 is a non-volatile memory that stores instructions and data when the computer system 1100 is on or off. The permanent storage 1140 is a read/write memory device, such as a hard disk or a flash drive. Storage media may be any available media that can be accessed by a computer. By way of example, the ROM could also be EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

The RAM 1125 is a volatile read/write memory. The RAM 1125 stores instructions needed by the processor(s) 1110 at runtime. The bus 1105 also connects input and output devices 1120 and 1130. The input devices enable the user to communicate information and select commands to the computer system. The input devices 1120 may be a keyboard or a pointing device such as a mouse. The input devices 1120 may also be a touch screen display capable of receiving touch interactions. The output device(s) 1130 display images generated by the computer system. The output devices may include printers or display devices such as monitors.

The bus 1105 also couples the computer system to a network 1135. The computer system may be part of a local area network (LAN), a wide area network (WAN), the Internet, or an Intranet by using a network interface. The web service may be provided to the user through a web client, which receives information transmitted on the network 1135 by the computer system 1100.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for” or, in the case of a method claim, the element is recited using the phrase “step for.”

1. A method comprising:
receiving subject information for a storyline;
receiving storyline content for the storyline, wherein the storyline content is related to the subject information;
generating the storyline with the story line content in a desired order; and
transmitting the storyline for presentation on a display.

2. The method of claim 1, further comprising designating a time period for the storyline.

3. The method of claim 1, further comprising receiving and presenting advertisements on the storyline.

4. The method of claim 1, further comprising applying a filter to the storyline content to aid in the presentation of the storyline content.

5. The method of claim 1, further comprising:
designating a portion of the storyline as private; and
designating a portion of the storyline as public.

6. The method of claim 1, further comprising creating access rights for editing storyline content and adding storyline content to the storyline.

7. The method of claim 1, further comprising:
receiving feedback for the storyline content; and
generating an award based on the feedback.

8. The method of claim 1, further comprising:
receiving a contribution to the storyline content; and
updating the storyline based upon the contributed storyline content.

9. The method of claim 8, further comprising generating and transmitting a notification based on the update.

10. The method of claim 8, further comprising:
identifying a contributor for contributed storyline content.

11. A system comprising:
at least one processor configured to:
receive subject information for a storyline;
receive storyline content for the storyline, wherein the storyline content is related to the subject information;
generate the storyline with the story line content in chronological order; and
transmit the storyline for presentation on a display.

12. The system of claim 11, wherein the processor is further configured to designate a time period for the storyline.

13. The system of claim 11, wherein the processor is further configured to receive and present advertisements on the storyline.

14. The system of claim 11, wherein the processor is further configured to apply a filter to the storyline content to aid in the presentation of the storyline content.

15. The system of claim 11, wherein the processor is further configured to designate a portion of the storyline as private and designate a portion of the storyline as public.

16. The system of claim 11, wherein the processor is further configured to create access rights for editing storyline content and adding storyline content to the storyline.

17. The system of claim 11, wherein the processor is further configured to receive feedback for the storyline content and generate an award based on the feedback.

18. The system of claim 11, wherein the processor is further configured to receive a contribution to the storyline content and update the storyline based upon the contributed storyline content.

19. The system of claim 18, wherein the processor is further configured to generate and transmit a notification based on the update.

20. The system of claim 18, wherein the processor is further configured to identify a contributor for contributed storyline content.

21. A computer program product comprising a machine-readable medium comprising instructions executable to:
receive subject information for a storyline;
receive storyline content for the storyline, wherein the storyline content is related to the subject information;
generate the storyline with the story line content in chronological order; and
transmit the storyline for presentation on a display.
